(19) United States
(12) Patent Application Publication
(10) Pub. No.: US 2017/0061676 A1
(43) Pub. Date: Mar. 2, 2017

(54) PROCESSING MEDICAL VOLUME DATA

(71) Applicants: VATECH Co., Ltd., Gyeonggi-do (KR); VATECH EWOO Holdings Co., Ltd., Gyeonggi-do (KR)

(72) Inventors: Se Yeol IM, Gyeonggi-do (KR); Dong Wan SEO, Gyeonggi-do (KR); Tae Hee HAN, Gyeonggi-do (KR)

(73) Assignees: VATECH Co., Ltd., Gyeonggi-do (KR); VATECH EWOO Holdings Co., Ltd., Gyeonggi-do (KR)

(21) Appl. No.: 15/250,868

(22) Filed: Aug. 29, 2016

(30) Foreign Application Priority Data
Aug. 27, 2015 (KR) 10-2015-0120950

(51) Int. Cl. G06T 15/08; G06T 19/20; G06T 7/00

(52) U.S. Cl. CPC G06T 15/08; G06T 7/0085; G06T 7/0081; G06T 19/20; G06T 2207/20148; G06T 2207/10081; G06T 2207/30008; G06T 2210/41; G06T 2219/2012

(57) ABSTRACT

The disclosure is related to processing volume data of a volume rendered image. In particular, volume data is processed to clearly show a feature region in the volume rendered image. Such processing may include obtaining volume data for producing a volume rendered image from a third entity, generating feature data associated with a feature region in the volume rendered image using the obtained volume data, generating threshold data by setting a predetermined threshold value associated with the feature data, performing a thresholding process on the volume data using the generated threshold data, and emphasizing the feature region by processing the thresholding-processed volume data using the threshold data.

### CROSS REFERENCE TO PRIOR APPLICATIONS

The present application claims priority under 35 U.S.C. §119 to Korean Patent Application No. 10-2015-0120950 (filed on Aug. 27, 2015).

### BACKGROUND

The present disclosure relates to producing a medical volume data image and, more particularly, to processing the medical volume data to clearly show a region of interest in an associated medical volume image.

A medical volume rendered image is frequently used by medical and health professions for various purposes, such as carefully observing and examining a patient's condition and explaining to a patient about a bone structure of a patient and about a medical procedure for curing a particular disease based on the patient's condition. Furthermore, such a medical volume rendered image may be used to produce a medical three dimensional (3D) model for experimenting or simulating a predetermined medical procedure.

The medical volume rendered image may be produced by performing a rendering process on medical volume data. The medical volume data is composed of voxel data of three-dimensional (3D) medical image. Such voxel data is a unit data for a medical volume image. Such a rendering process is a technique for displaying a medical volume data (e.g., 3D image data) in a two-dimensional (2D) projection image.

The medical volume data may be produced by capturing radiographic images of a patient using a three-dimensional (3D) medical imaging device, such as a computed tomography device (CT), a magnetic resonance imaging device (MRI), a positron emission tomography device (PET), a single photon emission computed tomography (SPECT).

In generally, such medical volume data includes a significant amount of noises. Accordingly, the medical volume rendered image also has a significant amount of noises. The noise is undesired data inserted into a medical volume data due to the dispersion of computed tomography (CT). In order to minimize and eliminate such noise of the medical volume rendered image, a coloring method may be generally used. The coloring method may adjust a color of a medical volume rendering image. That is, the coloring method may dynamically assign different brightness according to a CT number of each voxel (e.g., Hounsfield unit).

A medical volume rendered image includes a region of interest (ROI). Such a region of interest is an image region that a user (e.g., medical and health professions) wants to carefully observe. The region of interest is discriminated from a background region. The region of interest is generally referred to as a medical structure region including a soft bone and a hard tissue of a target object of a patient. The background region includes a soft tissue and background of the target object of the patient.

However, the coloring method has drawbacks. For example, when the coloring method is performed to eliminate noise influence, the brightness of a particular region (e.g., voxels having comparatively low CT number) significantly drops. Accordingly, an expression level of the particular region significantly drops. Such a particular region might be a region of interest because the region of interest generally is formed of voxels having comparatively low CT numbers.

Furthermore, when the coloring method is performed to improve the expression level of the image, overall noise influence becomes increased. Accordingly, sharpness of a region of interest becomes dropped significantly. For example, when a CT image of a head is controlled through coloring, a hard tissue (e.g., skull, cranial bone, and teeth) will be clearly displayed. However, sharpness and brightness of soft born structure having comparatively low CT number, such as a temporomandibular joint (TMJ) become significantly dropped.

As described, the coloring method has drawbacks, such as significantly dropping the brightness of voxels having a comparatively low CT number or significantly increasing influence of noise in the medical volume rendered image.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present disclosure overcome the above disadvantages and other disadvantages not described above. Also, embodiments of the present disclosure are not required to overcome the disadvantages described above, and embodiments of the present disclosure may not overcome any of the problems described above.

In accordance with at least one aspect, binary data associated with a predetermined region of a volume rendered image may be processed through at least one thresholding process in order to improve the display quality of the predetermined region of the volume rendered image.

In accordance with at least one embodiment, a method may be provided for processing volume data. The method may include obtaining volume data for producing a volume rendered image from a third entity, generating feature data associated a feature region in the volume rendered image using the obtained volume data, generating threshold data by setting a predetermined threshold value associated with the feature data, performing a thresholding process on the volume data using the generated threshold data, and emphasizing the feature region by processing the thresholding-processed volume data using the threshold data.

The feature region may be a region formed of voxels having comparatively high brightness value that neighbor voxels.

The generating feature data may include identifying the feature region in the volume rendered image based on voxel values, and extracting data associated with the identified feature region from the obtained volume data, as the feature data.

To identify the feature region and extract data associated with the identified feature region, a blob detection algorithm may be used. Such a blob detection algorithm may include at least one of a difference of Gaussians (DoG) algorithm, a laplacian of Gaussians (LoG) algorithm, and a determinant of hessian (DoH) algorithm.

The generating feature data may include calculating a first Gaussian value of each voxel of the volume data by performing a first Gaussian process on each voxel of the volume data with a comparatively small size of a mask, calculating a second Gaussian value of each voxel of the volume data by performing a second Gaussian process on each voxel of the volume data with a comparatively large size of a mask, calculating a difference value between the first Gaussian value of each voxel and the second Gaussian value of a corresponding voxel, detecting voxels having negative difference values among voxels of the volume data based on the calculated difference values, and extracted detected voxels from the volume data.

The generating threshold data may include performing a first thresholding process on the feature data using a predetermined threshold filter and determining, as the threshold data, threshold values of the feature data by performing an averaging process on each voxel of the first thresholding-processed feature data using a predetermined size of a mask.

The performing a first thresholding process may include comparing a predetermined threshold filter value and a corresponding voxel value of the feature data, selecting a value greater than the other based on the comparison result, and assigning the selected value to the corresponding voxel of the feature data.

The performing a thresholding process on the volume data may include comparing each voxel value of the generated threshold data and a corresponding voxel value of the volume data, selecting one greater than the other, and assigning the selected one to the corresponding voxel value of the volume data.

The emphasizing the feature region may include processing each voxel of the thresholding-processed volume data using a predetermined sobel mask and generating volume data processing results, processing each voxel of the threshold data using a predetermined sobel mask and generating threshold data processing results, comparing the generated volume data processing results and the threshold data processing results, and setting at least one of the volume data processing results to a predetermined reference value when the one is smaller than a corresponding threshold data processing result.

The method may further include performing a Gaussian process on each voxel of the emphasized volume data and performing a noise eliminating process on the Gaussian processed volume data.

The performing a noise eliminating process may include comparing each voxel of the Gaussian processed volume data with adjacent voxels, selecting the smallest voxel value based on the comparison result, and allocating the selected smallest voxel value as the corresponding voxel of the Gaussian processed volume data.

In order to emphasize the feature region, an edge detection algorithm may be used. Such an edge detection algorithm may include a sobel operator, a differential edge detection, and a canny edge detector.

In accordance with another embodiment, a non-transitory computer readable recording medium may be provided. Such a non-transitory computer readable recording medium, which when executed, performs a method of processing volume data. The method may include obtaining volume data for producing a volume rendered image from a third entity, generating feature data associated a feature region in the volume rendered image using the obtained volume data, generating threshold data by setting a predetermined threshold value associated with the feature data, performing a thresholding process on the volume data using the generated threshold data, and emphasizing the feature region by processing the thresholding-processed volume data using the threshold data.

### BRIEF DESCRIPTION OF THE DRAWINGS

The above and/or other aspects of some embodiments of the present invention will become apparent and more readily appreciated from the following description of embodiments, taken in conjunction with the accompanying drawings, of which:

FIG. 1 illustrates a device for processing volume data in accordance with at least one embodiment of the present disclosure;

FIG. 2 illustrates a detailed configuration of a processor of a panoramic radiograph producing apparatus in accordance with at least one embodiment;

FIG. 3 is a flowchart describing an overall operation of a volume data processing device in accordance with at least one embodiment;

FIG. 4 is a flowchart for identifying a feature region and creating feature data by extracting data associated with the identified feature region from volume data in accordance with at least one embodiment;

FIG. 5 illustrates an exemplary cross sectional view produced based on volume data in accordance with at least one embodiment;

FIG. 6 illustrates a same cross section view produced based on feature data in accordance with at least one embodiment;

FIG. 7 is a flowchart for describing generating threshold data in accordance with at least one embodiment;

FIG. 8 illustrates the same cross sectional view produced from thresholding processed feature data after performing a thresholding process in accordance with at least one embodiment;

FIG. 9 illustrates the same cross sectional view produced from threshold data in accordance with at least one embodiment;

FIG. 10 illustrates the same cross sectional view produced from thresholding processed volume data in accordance with at least one embodiment;

FIG. 11 is a flowchart describing an emphasizing process for emphasizing a feature region in accordance with at least one embodiment;

FIG. 12 illustrates the same cross sectional view produced from volume data processing results in accordance with at least one embodiment;

FIG. 13 illustrates the same cross sectional view produced from threshold data processing results in accordance with at least one embodiment;

FIG. 14 illustrates the same cross sectional view produced from the emphasized volume data in accordance with at least one embodiment; and

FIG. 15 and FIG. 16 illustrate comparison between a volume rendered image produced a related art and a volume rendered image produced in accordance with at least one embodiment

### DETAILED DESCRIPTION OF EMBODIMENTS

Reference will now be made in detail to exemplary embodiments of the present disclosure, examples of which are illustrated in the accompanying drawings, wherein like reference numerals refer to like elements throughout. The embodiments are described below, in order to explain embodiments of the present disclosure by referring to the figures.

In accordance with at least one embodiment, a medical volume data may be processed for clearly expressing a region of interest in a medical volume rendered image. That is, a feature region of a medical volume rendered image may be clearly expressed with or without filtering noises in the volume image data in accordance with at least one embodiment.

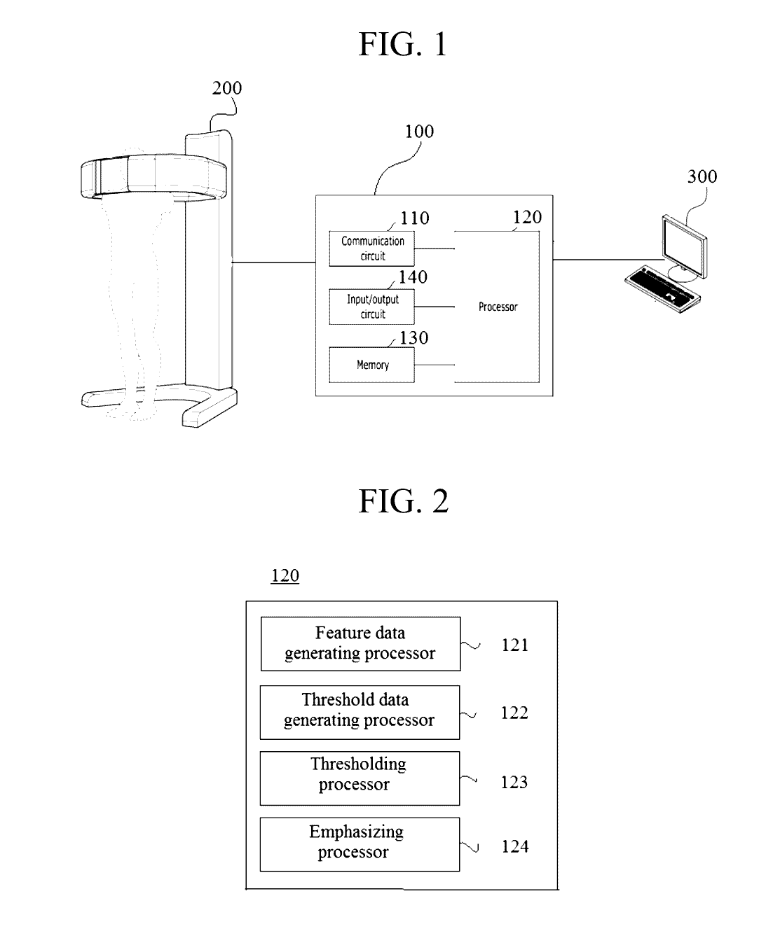

FIG. 1 illustrates a device for processing volume data in accordance with at least one embodiment of the present disclosure.

Referring to FIG. 1, volume data processing device 100 may obtain data for a volume rendered image (e.g., 3D radiograph) of a target object from other entities and process the obtained data to clearly show a structure region in the volume rendered image (e.g., 3D radiograph) of the target object in accordance with at least one embodiment. The volume rendered image (e.g., 3D radiograph) of the target object may include digital information for producing a panoramic radiograph of the same target object. Such 3D radiograph digital information may be voxel data of a 3D radiograph for expressing the target object in three dimensions.

Such volume data processing device 100 may be connected to medical 3D imaging device (e.g., 3D CT scanner) 200 and display 300 in accordance with at least one embodiment. Such a medical 3D imaging device (e.g., 3D CT scanner) 200 may produce at least one of volume data and low data for a volume rendered image (e.g., 3D radiograph) of a target object and provide the produced volume data or low data to volume data processing device 100. Display 300 may receive processed volume data produced and processed by volume data processing device 100 and display the received volume data in response to an operator's control.

For example, medical 3D imaging device 200 (e.g., 3D CT scanner) may be a typical 3D radiography machine such as a cone beam computed tomography (CBCT) and a computed tomography (CT). Display 300 may be a device for displaying a volume rendered image produced by volume data processing device 100. Display 300 may be various types of a display device, such as a liquid crystal display (LCD), a light emitting diode (LED) display, an active matrix organic light emitting diode (AMOLED) display, a cathode ray tube (CRT) display, and likes.

In FIG. 1, display 300 is illustrated as a device separated and independent from medical 3D imaging device 200 and volume data processing device 100, but the embodiments of the present disclosure are not limited thereto. For example, such display 300 may be implemented within at least one of medical 3D imaging device 200 and volume data processing device 100.

As shown in FIG. 1, volume data processing device 100 is also illustrated as an independent single apparatus separated from medical 3D imaging device 200 and display 300. However, embodiments of the present disclosure are not limited thereto. For example, volume data processing device 100 may be implemented inside medical 3D imaging device 200 with display 300, as single machine. For another example, volume data processing device 100 may be implemented as a circuit board attachable to or detachable from a predetermined slot in a circuit board. Such volume data processing device 100 may be inserted at a predetermined slot of a typical medial 3D imaging device. In this case, volume data processing device 100 may use constituent elements (e.g., processors or memoires) of the typical medical 3D imaging device for producing a panoramic radiograph. Furthermore, volume data processing device 100 may be implemented as a circuitry card with a predetermined communication interface such as a universal serial bus (USB) interface. Such volume data processing device 100 may be coupled with a typical medical 3D imaging device through a USB slot. In this case, volume data processing device 100 may use constituent elements (e.g., processors or memoires) of the typical medical 3D imaging device for producing a volume rendered image. Furthermore, volume data processing device 100 may be implemented as software program or application and installed in a typical medical 3D imaging device. In this case, upon installing and execution of the predetermined software program, a typical medical 3D imaging device might produce a volume rendered image by controlling constitute elements of the typical medical 3D imaging device.

As another example, volume data processing device 100 may be located a comparatively long distance from medical 3D imaging device 200. In this case, volume data processing device 100 may be connected to medical 3D imaging device 200 through a communication network. As still another example, volume data processing device 100 may be not coupled to medical 3D imaging device 200. In this case, volume data processing device 100 may obtain volume data, low data, or volume rendered images i) by downloading from other entities coupled through a communication network, ii) from a secondary external memory coupled thereto through a predetermined interface, iii) inputted by an operator through an input circuit of volume data processing device 100. However, embodiments of the present disclosure are not limited thereto.

Hereinafter, such volume data processing device 100 will be described in more detail. As shown in FIG. 1, volume data processing device 100 may include communication circuit 110, processor (e.g., central processing unit) 120, memory 130, and input and output circuit 140 in accordance with at least one embodiment.

Communication circuit 110 may be a circuit for communicating with other entities coupled to volume data processing device 100. Such communication circuit 110 may enable volume data processing device 100 to communicate with other entities through a communication network. For example, communication circuit 110 may establish at least one of wireless and wired communication links to other entities (e.g., medical 3D imaging device 200 and display 300) through a communication network or directly. Through the established communication links, the communication circuit 110 may receive information from or transmit information to medical 3D imaging device 200 and display 300.

Furthermore, communication circuitry 110 transmits and receives signals to/from other entities through a communication network based on various types of communication schemes. Communication circuitry 110 may be referred to as a transceiver and include at least one of a mobile communication circuit, a wireless internet circuit, a near field communication (NFC) circuit, a global positioning signal receiving circuit, and so forth. Particularly, communication circuit 110 may include a short distance communication circuit for short distance communication, such as NFC, and a mobile communication circuit for long range communication through a mobile communication network, such as long term evolution (LTE) communication or wireless data communication (e.g., WiFi). In addition, communication circuit 110 may provide a communication interface between panoramic radiograph producing apparatus with other entities using various communication schemes.

Input/output circuit 140 may receive various types of signals from an operator for controlling volume data processing device 100 in accordance with at least one embodiment. Input circuitry 140 may include a keyboard, a keypad, a touch pad, a mouse, and likes. In addition, input circuitry 140 may be a graphic user interface capable of detecting a touch input.

Furthermore, Input/output circuitry 140 may provide an interface for receiving input information from other entities including an operator and providing information to other entities. Such input/output circuitry 140 may be realized to support in various types of standardized protocols and interface schemes.

Memory 130 may store various types of information, generated in volume data processing device 100 and received from other entities such as medical 3D imaging device 200. Memory 130 may further store various types of applications and software programs for controlling constituent elements or performing operations associated with producing volume rendered image (e.g., panoramic radiograph) using volume data (e.g., 3D radiograph digital data) and processing the volume data to clearly show a predetermined region in the volume rendered image.

In accordance with at least one embodiment, memory 130 may store intermediate image data (e.g., volume data, threshold data, feature data, thresholding processed volume data, thresholding processed feature data,) generated for producing a volume rendered image (e.g., panoramic radiograph), processing volume data, information and variables necessary to perform operations for producing the panoramic radiograph (e.g., information on a sobel operator, information on a threshold filter, a thresholding process, a threshold value, information on a size of a mask, information on a Gaussian function) and processing the volume data. For example, memory 130 may store various types of image data, such as image data in a digital imaging and communications in medicine (DICOM) type, a BMP type, a JPEG type, and a TIFF type.

Memory 130 may further store software programs and a firmware. Memory 130 may include a flash memory, a hard disk, a multimedia card (MMC), a secure digital card, an extreme digital card, a random access memory (RAM), a static random access memory (SRAM), a read-only memory (ROM), an electrically erasable programmable read-only memory (EEPROM), a programmable read-only memory, a magnetic resistive random access memory, a magnetic disk, and an optical disk. However, the embodiments of the present disclosure are not limited thereto.

Processor 120 may control constituent elements of volume data processing device 100 and perform operations for processing volume data for clearly displaying a region of interest in a volume rendered image and producing a volume rendered image using the processed volume data. For example, processor 120 may perform operations of i) obtaining volume data from a third entity, ii) identifying a feature region in the obtained volume data and generating feature data by extracting data associated with the identified feature region from the obtained volume data, iii) generating threshold data by a) setting at least one threshold value of the feature data and b) performing a thresholding process on the feature data using the at least one threshold value, iv) performing a thresholding process on the volume data using the generated threshold data, v) performing an emphasizing process on the feature region, and vi) displaying the processed volume data with the emphasized feature region.

In addition, processor 120 may control constituent elements of other coupled devices, such as medical 3D imaging device 200 and display 300, in cooperation with the coupled devices, and perform operations associated with the coupled devices in cooperation with the coupled devices.

Processor 120 may be referred to as a central processing unit (CPU). For example, processor 120 may include an application specific integrated circuit (ASIC), a digital signal processor (DPS), a digital signal processor (DSP), a programmable logic device (PLS), field-programmable gate array (FPGA), processors, controllers, micro-controller, a microprocessor. Processor 120 may be implemented as a firmware/software module. Such a firmware/software module may be implemented by at least one of software applications written by at least one program languages.

As described, processor 120 may perform i) operations for obtaining volume data, ii) operations for processing the obtained volume data to clearly show a predetermined region of an associated volume rendered image, and iii) operations for displaying the processed volume data. In order to perform such operations, processor 120 may include additional processors. Such configuration of processor 120 will be described with reference to FIG. 2.

FIG. 2 illustrates a detailed configuration of a processor of a panoramic radiograph producing apparatus in accordance with at least one embodiment.

Referring to FIG. 2, as described, processor 120 may perform operations for processing the obtained volume data to clearly show a predetermined region of an associated volume rendered image. Such processor 120 may include feature data generating processor 121, threshold data generating processor 122, thresholding processor 123, and emphasizing processor 124.

For example, feature data generating processor 121 may perform operations for identifying a feature region in the obtained volume data and generating feature data by extracting data associated with the identified feature region from the obtained volume data. In particular, feature data generating processor 121 may perform operations for a) calculating a first Gaussian value of each voxel of the volume data by performing a first Gaussian process on each voxel of the volume data with a comparatively small size of a mask, b) calculating a second Gaussian value of each voxel of the volume data by performing a second Gaussian process on each voxel of the volume data with a comparatively large size of a mask, c) calculating a difference value between the first Gaussian value of each voxel and the second Gaussian value of a corresponding voxel, and d) identifying a feature region and generating feature data by extracting data associated with the identified feature region from the volume data.

Threshold data generating processor 122 may perform operations generating threshold data by i) setting at least one threshold value of the feature data and ii) performing a thresholding process on the feature data using the at least one threshold value

Thresholding processor 123 may perform operations performing a thresholding process on the volume data using the generated threshold data by i) comparing each voxel value of the threshold data and a corresponding voxel value of the volume data, ii) selecting one greater than the other, and iii) assigning the selected one to the corresponding voxel value of the volume data in accordance with at least one embodiment.

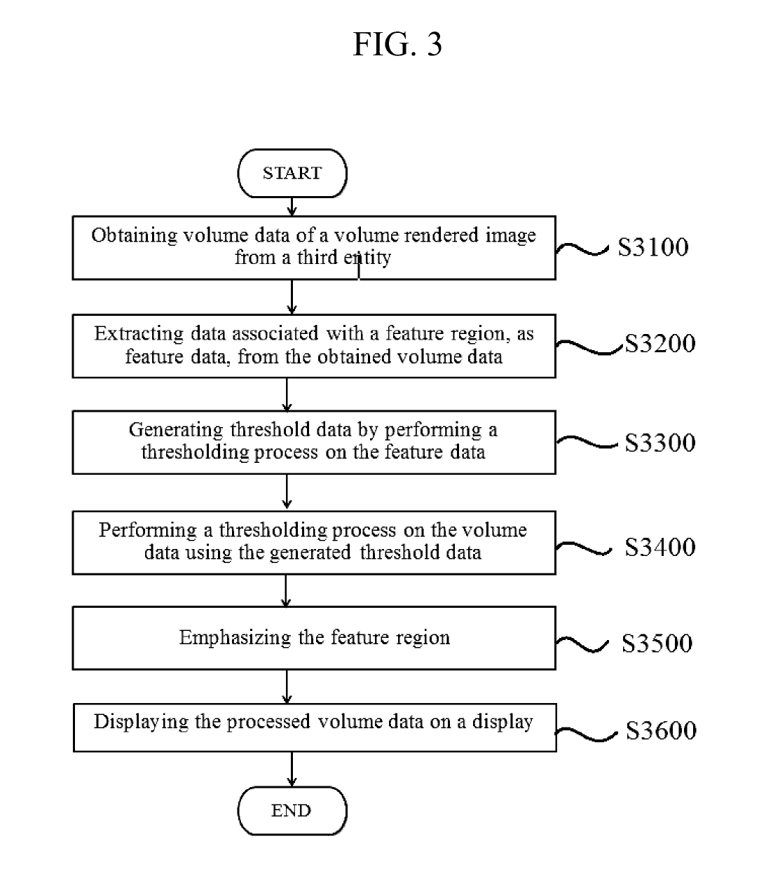

Emphasizing processor 124 may perform operation performing an emphasizing process on the feature region by i) processing the threshold processed volume data with a predetermined sobel mask, ii) processing the threshold data using a sobel mask, iii) comparing the processed data and changing a predetermined voxel value to a reference value upon a predetermined condition is satisfied, iv) performing a Gaussian process on the emphasized volume data, and v) eliminating noises from the emphasized volume data. Such operations of processor 120 will be described in more detail with reference to FIG. 3 to FIG. 16.

As described above, volume data processing device 100 may process binary data associated with a predetermined region (e.g., a region of interest, a feature region, or a structure region) of a volume rendered image through at least one thresholding process in order to improve the display quality of the predetermined region of the volume rendered image in accordance with at least one embodiment. Hereinafter, operations of volume data processing device 100 will be described in detail with reference to FIG. 3 to FIG. 16.

FIG. 3 is a flowchart describing an overall operation of a volume data processing device in accordance with at least one embodiment. That is, the flowchart of FIG. 3 illustrates a method for processing volume data to clearly express a feature region in a medical volume rendered image in accordance with at least one embodiment of the present disclosure.

Referring to FIG. 3, in order to process volume data for clearly displaying a region of interest in a volume rendered image, volume data processing device 100 may perform operations of: obtaining volume data from a third entity at step S3100; identifying a feature region in the obtained volume data and generating feature data by extracting data associated with the identified feature region from the obtained volume data at step S3200; generating threshold data by i) setting at least one threshold value of the feature data and ii) performing a thresholding process on the feature data using the at least one threshold value at step S3300; performing a thresholding process on the volume data using the generated threshold data at step S3400; performing an emphasizing process on the feature region at step S3500; and displaying the processed volume data with the emphasized feature region at step S3600.

Hereinafter, each operation of volume data processing device 100 will be described with accompanying drawings. As described, volume data of a medical volume image (e.g., 3D radiograph) may be obtained from a third entity at step S3100. For example, volume data processing device 100 may obtain volume data of a 3D image of a target object (e.g., patient) directly from a third entity. The 3D image may be referred to a medical volume rendered image, a volume rendered image, or a 3D radiography, but not limited thereto. The third entity may be a 3D medical imaging device, such as CT scanner 200, but not limited thereto. Alternatively, instead of directly obtaining the volume data of the volume rendered image, volume data processing device 100 may obtain low data from the third entity and generate the volume data thereof by processing (e.g., reconfiguring) the received low data.

In accordance with at least one embodiment, volume data processing device 100 obtains volume data (e.g., 3D radiograph digital data) of a volume rendered image of a patient from 3D CT scanner 200. In particular, such volume data (e.g., 3D radiograph digital data) may be received from 3D CT scanner 200 through communication interface 110. The volume data (e.g., 3D radiograph digital data) may be digital data of a 3D radiograph, captured and produced by 3D CT scanner 200. That is, the volume data (e.g., 3D radiograph digital data) may be produced by scanning a target object of a patent (e.g., a head) in multiple directions by radiating X-ray and collecting x-ray images formed on a light receiving plane (e.g., x-ray sensor). Such volume data may be a set of voxel values in order to display the scanned target object of the patient on display 300 in three dimensions. A voxel is a basic unit of a 3D radiograph, which represents a 3D surface geometry of an object.

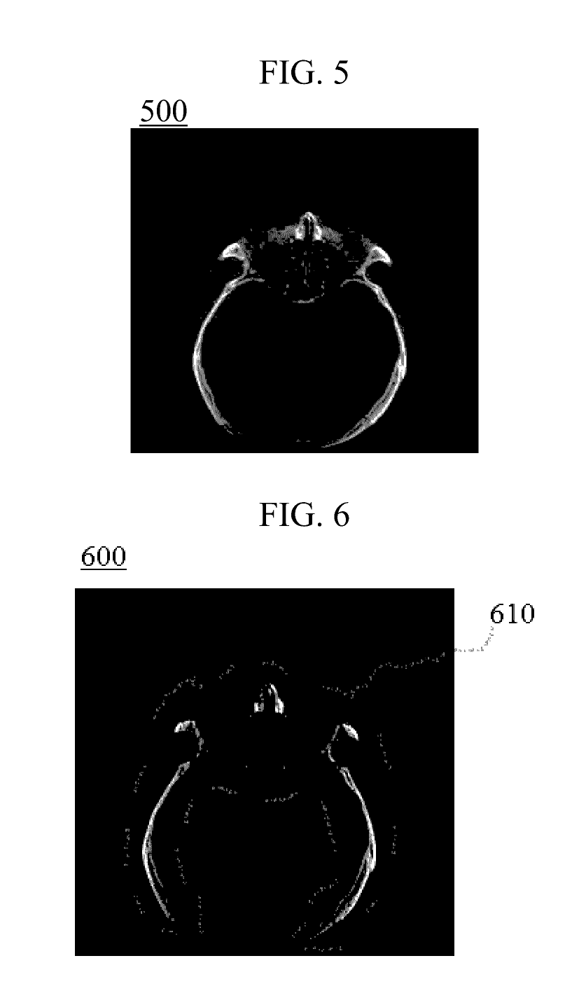

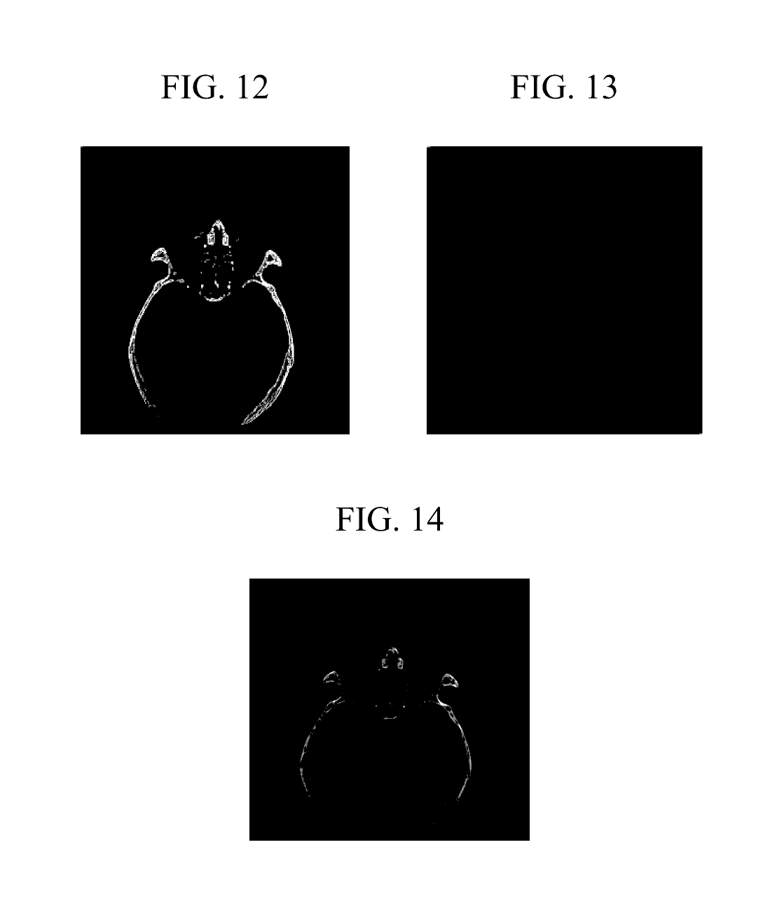

That is, volume data processing device 100 receives, from 3D CT scanner 200, such volume data (e.g., 3D radiograph digital data) that includes a set of voxel values representing a patient's target object in three dimensions. By analyzing and processing such volume data (e.g., 3D radiograph digital data), various images of a patient's target object may be produced and displayed through predetermined display devices. For example, FIG. 5, FIG. 6, FIG. 8 to FIG. 10, and FIG. 12 to FIG. 16 illustrate various images produced based on the received volume data. Furthermore, volume data processing device 100 may store the received volume data in memory 130.

As described, volume data processing device 100 is described as receiving such volume data from 3D CT scanner 200, but the embodiments of the present disclosure are not limited thereto. For example, volume data processing device 100 may obtain such volume data through various manners, such as receiving from other entities (e.g., a service server, a personal computer, or another medical equipment located at a remote location) connected through a communication network, receiving from a secondary external memory device (e.g., a USB memory, a portable memory stick, a portable memory bank) coupled directly to volume data processing 100, downloading from a predetermined cloud storage through a communication network or a predetermined webpage, or likes. Furthermore, volume data processing device 100 may obtain the volume data produced previously and stored in a predetermined storage device for comparatively long time such as days, months, or yrs.

After obtaining the volume data, a feature region (e.g., a region of interest) in the volume data image (e.g., 3D radiograph) may be identified, and feature data associated with the identified feature region may be extracted from the obtained volume data at step S3200, as described above. In particular, a feature region may denote a region of interest in a 3D radiograph. Such a feature region may be a region composed of voxels each having a value comparatively greater than neighbor voxels. Such a feature region may be identified using a blob detection algorithm.

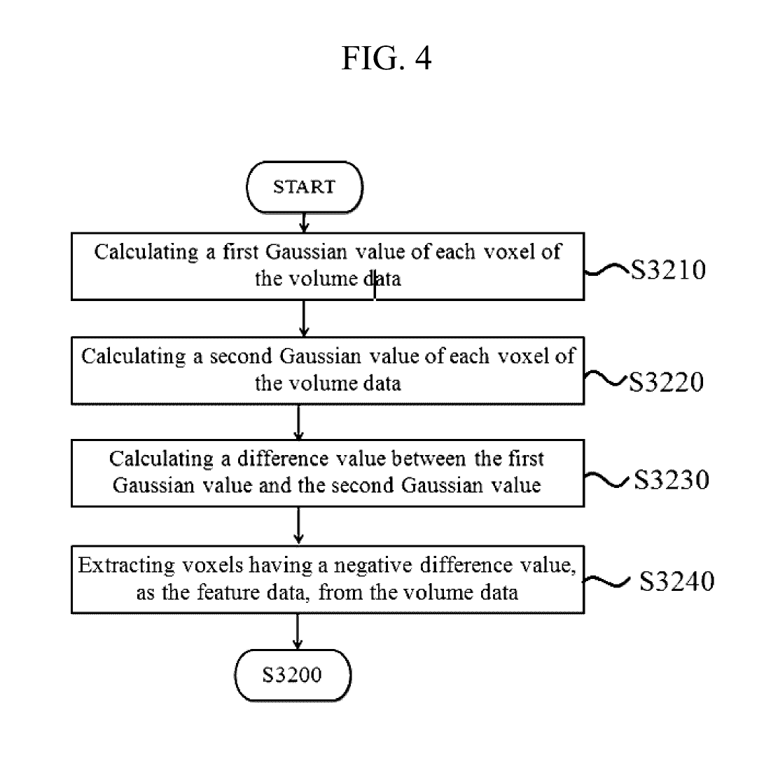

In accordance with at least one embodiment, processor 120 of volume data processing device 100 may perform operations for identifying the feature region using a blob detection algorithm. The blob detection algorithm may include a difference of Gaussians (DoG) algorithm, a laplacian of Gaussians (LoG) algorithm, a determinant of hessian (DoH) algorithm. In accordance with at least one embodiment, volume data processing device 100 may use the DoG algorithm to identify the first feature region and to extract the first feature data from the obtained volume data. However, the present disclosure is not limited thereto. For example, the other algorithms may be used for extracting feature data associated with the identified feature region (e.g., structure regions) from the volume data. Hereinafter, the operation for creating the feature data will be described in more detail with reference to FIG. 4 to FIG. 6.

FIG. 4 is a flowchart for identifying a feature region and creating feature data by extracting data associated with the identified feature region from volume data in accordance with at least one embodiment.

Referring to FIG. 4, at step S3210, a first Gaussian value of each voxel of the volume data may be calculated by performing a first Gaussian process on each voxel of the volume data with a comparatively small size of a mask. In accordance with at least one embodiment, processor 120 of volume data processing device 100 performs a first Gaussian function on the obtained volume data with the comparatively small size of a mask to calculate first Gaussian values of voxels of the volume data. That is, processor 120 may read a sequence of voxel values of the obtained volume data which are stored in memory 130, apply the first Gaussian function on the read voxel values, and calculate a first Gaussian value of each voxel based on the result of the first Gaussian function. After calculating, processor 120 may store the calculated first Gaussian values in memory 130. Herein, the comparatively small size of a mask may be previously determined by at least one of a user and a system designer, or based on accumulated related statistical data,

At step S3220, a second Gaussian value of each voxel of the volume data may be calculated by performing a second Gaussian process on each voxel of the volume data with a comparatively large size of a mask. In accordance with at least one embodiment, the comparatively large size of a mask is larger than the size of the mask used in the first Gaussian process. Furthermore, processor 120 of volume data processing device 100 performs the second Gaussian function on the obtained volume data with the comparatively large size of a mask to calculate the second Gaussian value of each voxel of the volume data. That is, processor 120 may read a sequence of voxel values of the obtained volume data stored in memory 130, apply the second Gaussian function on the read voxel values, and calculate a second Gaussian value of each voxel based on the result of the Gaussian function. After calculating, processor 120 may store the calculated second Gaussian values in memory 130. Herein, the comparatively large size of a mask may be previously determined by at least one of a user and a system designer, or based on accumulated related statistical data,

At step S3230, a difference value between the first Gaussian value of each voxel and the second Gaussian value of a corresponding voxel may be calculated. For example, processor 120 may read the stored first and second Gaussian values, compares the read corresponding first and second Gaussian values, and calculate different values between corresponding first and second Gaussian values. After calculation, processor 120 of volume data processing device 100 may store the calculated difference values in memory 130.

At step S3240, a feature region may be identified, and feature data may be created. For example, processor 120 of volume data processing device 100 detects voxels having negative difference values among voxels of the volume data and identifies a regions formed of the detected voxels as the feature region. Processor 120 extracts the detected voxels from the volume data and generates feature data based on the detected voxels. For example, processor 120 may store the extracted voxels as the feature data as generating the feature data. Processor 120 stores the generated feature data in memory 130.

For example, FIG. 5 illustrates an exemplary cross sectional view produced based on volume data in accordance with at least one embodiment. That is, cross section view 500 may be produced using volume data obtained from medical 3D imaging device 100. FIG. 6 illustrates a same cross section view produced based on feature data in accordance with at least one embodiment. Referring to FIG. 6, cross sectional view 600 may be produced using feature data extracted from the volume data. Cross section view 600 shows the same section of FIG. 5 but using different low data, such as feature data which is processed from the volume data. As shown in FIG. 6, the identified feature region 610 is more clearly showed.

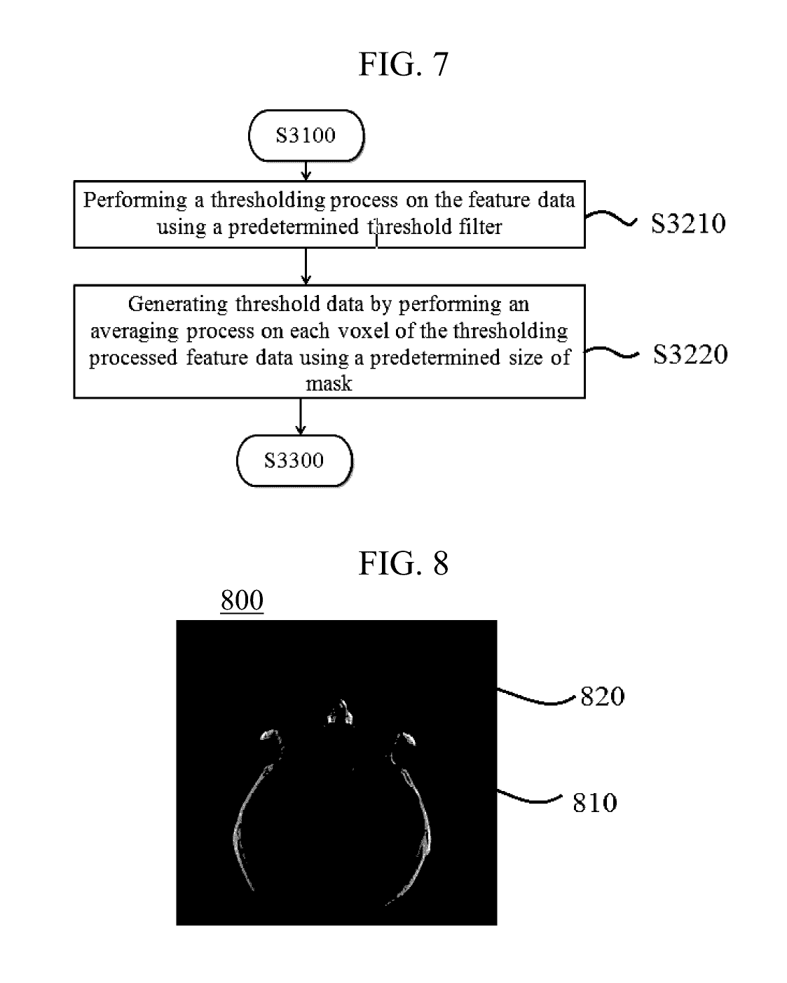

After generating the feature data, threshold data may be generated by determining at least one threshold value of the generated feature data at step S3300 as described above. Such generation of the threshold data will be described in more detail with reference to FIG. 7.

FIG. 7 is a flowchart for describing generating threshold data in accordance with at least one embodiment.

Referring to FIG. 7, a thresholding process may be performed on the feature data using a predetermined threshold filter at step S3310. For example, processor 120 of volume data processing device 100 may perform the thresholding process. In particular, processor 120 performs operations of i) comparing a predetermined threshold filter value and a corresponding voxel value of the feature data, ii) selecting a value greater than the other based on the comparison result, and iii) assigning the selected value to the corresponding voxel of the feature data.

Such a predetermined threshold filter may be previously defined by at least one of a user and a system designer or based on accumulated statistical data and stored in memory 130. The predetermined threshold filter may examine each voxel value and changes the examined voxel value to a predetermined value when the examined voxel value does not meet a predetermined boundary condition. By defining the threshold filter, the expression level, such as brightness, sharpness, and color of a feature region and a boundary thereof may be controlled accordingly.

In accordance with at least one embodiment, the predetermined threshold filter may be applied to i) boundary voxels corresponding to an outer-most contour line of the feature region and ii) neighbor voxels in a predetermined distance from the boundary voxels. For example, the boundary voxels may be voxels having a column value or a line value, greater than a predetermined reference value, such as “0.” The predetermined threshold filter changes such boundary voxels and the neighbor voxels to a predetermined value.

Furthermore, information on the thresholding process including the threshold filter, the predetermined threshold filter value may be determined by at least one of a user and a system designer based on accumulated statistical related data and stored in memory 130, but not limited thereto.

FIG. 8 illustrates the same cross sectional view produced from thresholding processed feature data after performing a thresholding process in accordance with at least one embodiment. As shown in FIG. 8, cross sectional view 800 shows resultant of performing the threshold filter that gradually decreases voxel values of the outmost contour line and neighbor voxels within a predetermined distance. That is, boundary region 810 of feature region (e.g., 610 in FIG. 6) becomes darker and clearer, and background region 820 becomes brighter and blurred as a result of performing the thresholding process, as compared to FIG. 6.

Referring back to FIG. 7, at step S3320, threshold values of the feature data may be determined, as the threshold data, by performing an averaging process on each voxel of the thresholding processed feature data using a predetermined size of a mask. For example, processor 120 performs an operation for calculating average values of voxels of the threshold data using a predetermined size of a mask and sets threshold values of the volume data using the calculated average values. Such a predetermined size of a mask may be previously determined by at least one of a user or a system designer or based on accumulated statistical related data. Based on such a predetermined size of a mask, the number of voxels and relation among the voxels may be defined for calculating an average value in accordance with at least one embodiment.

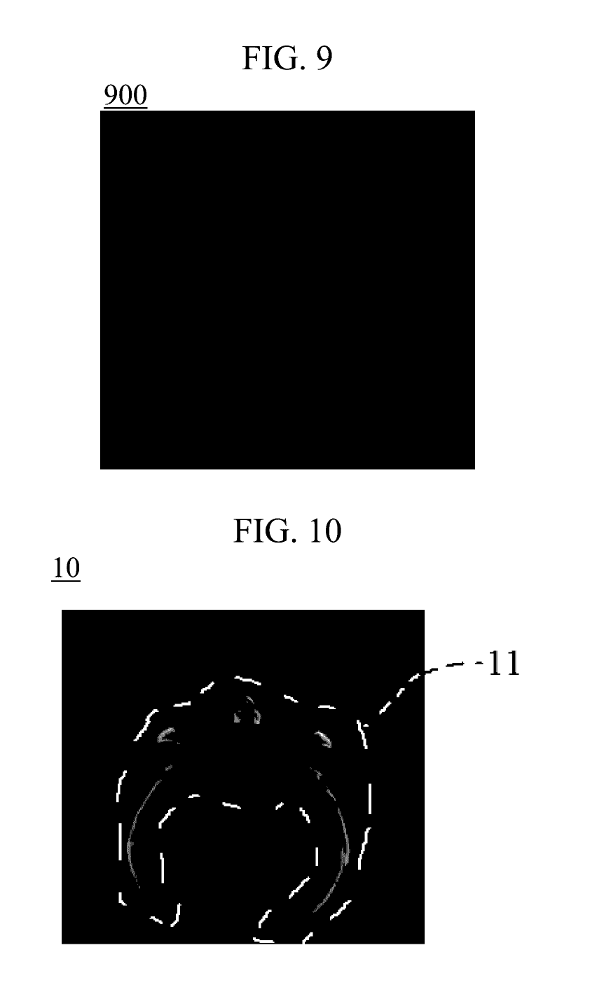

FIG. 9 illustrates the same cross sectional view produced from threshold data in accordance with at least one embodiment. As shown in FIG. 9, the sharpness of cross sectional view 900 becomes decreased.

After generating the threshold data, using the generated threshold data, a thresholding process may be performed on the volume data at step S3400. For example, processor 120 of volume data processing device 100 may perform a thresholding operation with a predetermine threshold value. In particular, processor 120 may i) compare each voxel value of the threshold data and a corresponding voxel value of the volume data, ii) selecting one greater than the other, and iii) assign the selected one to the corresponding voxel value of the volume data in accordance with at least one embodiment.

As described, such a predetermined threshold value and/or a threshold filter used for the thresholding process may be determined by at least one of a user and a system designer or based on accumulated statistical data, but not limited thereto, and stored in memory 130.

FIG. 10 illustrates the same cross sectional view produced from thresholding processed volume data in accordance with at least one embodiment. As shown in FIG. 10, feature region 11 becomes clearer and sharpener, as compared to the other drawings such as FIG. 5 and FIG. 9.

After the thresholding process on the volume data using the threshold data, the feature region may be emphasized at step S3500, as described above. In accordance with at least one embodiment, the feature region of the thresholding processed volume data may be emphasized by emphasizing at least one of brightness and color of a region composed with voxels having higher voxel values than neighbor voxels. For example, such emphasizing process increases the voxel values of the feature region and decreases the voxel values of neighbor regions. For such emphasizing process, an edge detection algorithm may be used. The edge detection algorithm may include a sobel operator, a differential edge detection, and a canny edge detector. For convenience and ease of understanding, embodiments will be described as using the sobel operator for the emphasizing operation. However, the present disclosure is not limited thereto.

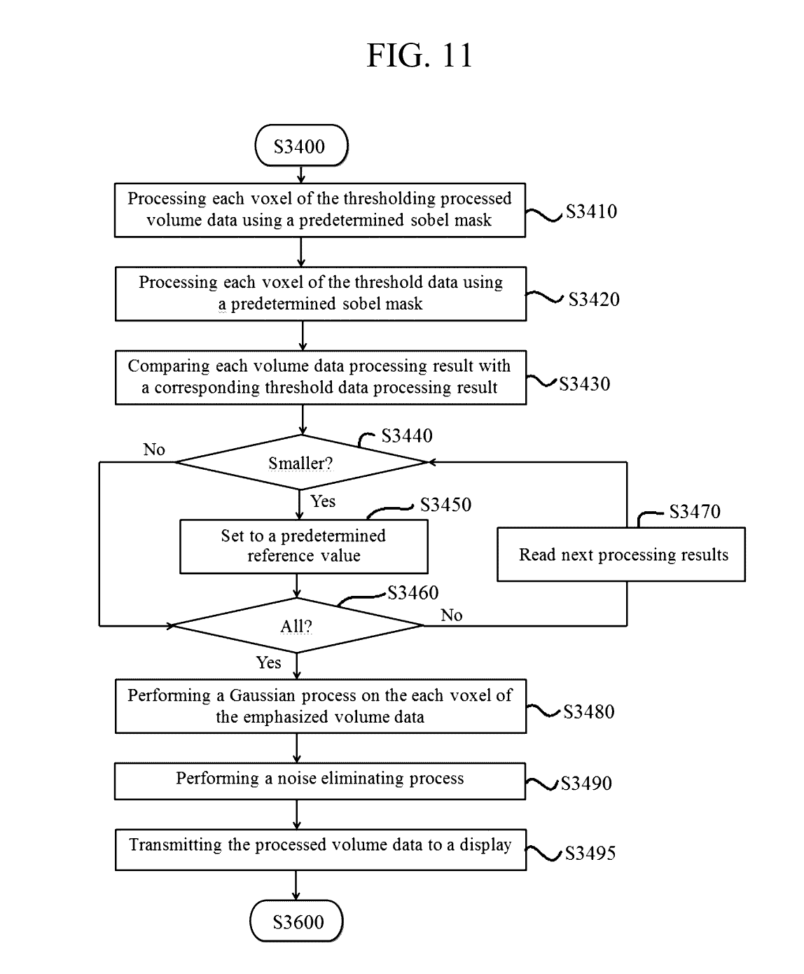

Hereinafter, such an emphasizing process will be described in detail with reference to FIG. 11. FIG. 11 is a flowchart describing an emphasizing process for emphasizing a feature region in accordance with at least one embodiment.

Referring to FIG. 11, each voxel of the thresholding processed volume data (e.g., resultant of S3400) may be processed using a predetermined sobel mask at step S3510. For example, processor 120 of volume data processing device 100 may read the thresholding processed volume data and information on a sobel mask from memory 130 and process each voxel of the thresholding processed volume data using the information on the sobel mask. Such a sobel mask may be referred to as a sobel filter or a sobel-feldman operator. Information on the sobel mask may be previously determined by at least one of a user and a system designer based on accumulated statistical related data and stored in memory 130. After processing, processor 120 may store the processing results as volume data processing results in memory 130.

At step S3520, each voxel of the threshold data (e.g., resultant of S3300) may be processed using a sobel mask. For example, processor 120 may read the threshold data and information on a sobel mask from memory 130 and process each voxel of the threshold data using the information on the sobel mask. The sobel mask (e.g., sobel filter, sobel operator) used in step S3520 may be identical to that used in step S3510. However, embodiments of the present disclosure are not limited thereto. As described, such a sobel mask may be referred to as a sobel filter, a sobel operator, or a sobel-feldman operator. Information on the sobel mask may be previously determined by at least one of a user and a system designer based on accumulated statistical related data and stored in memory 130. may be previously stored in memory 130. After processing, processor 120 may store processing results as threshold data processing results in memory 130.

At step S3530, each volume data processing result may be compared with a corresponding threshold data processing result. For example, processor 120 may fetch the stored volume data processing results and the threshold data processing result and compares each one of the volume data processing results with a corresponding one of the threshold data processing results.

At step S3540, determination may be made whether the volume data processing result is smaller than the corresponding threshold data processing result. For example, processor 120 may perform operation for determining whether the volume data processing result is smaller than the corresponding threshold data processing result.

When the volume data processing result is smaller than the corresponding threshold data processing result (Yes—S3540), the volume data processing result is set to a predetermined reference value, such as 0 at step S3550. For example, processor 120 sets the volume data processing result to the predetermined reference value, such as 0. Such a predetermined reference value may be previously determined by at least one of a user and a system designer based on accumulated statistical related data and stored in memory 130, but the present disclosure is not limited thereto.

Otherwise, determination may be made whether all of results are compared without changing the volume data processing result at step S3560. That is, processor 120 maintains the volume data processing result without changing to the predetermined reference value.

When all of results are not compared (No—S3560), a next volume data processing result may be compared with a corresponding threshold data processing result at step S3570. As described, processor 120 reads the next volume data processing result and the corresponding threshold data processing result and compares them. Then, processor 120 may perform operations for step 3540, S3550, and S3560 until all of the processing results are compared.

When all of results are compared (Yes—S3560), a Gaussian process may be performed on the each voxel of the emphasized volume data at step S3580. For example, processor 120 performs a Gaussian process on each voxel of the emphasized volume data. The emphasized volume data may be the sobel processed volume data with the selected voxels changed to the predetermined reference value as a result of step S3550.

At step S3590, a noise eliminating process may be performed. For example, processor 120 may perform the noise eliminating process by i) comparing each voxel of the Gaussian processed volume data with adjacent voxels (e.g., one left adjacent voxel and one right adjacent voxel), ii) selecting the smallest voxel value based on the comparison result, and iii) allocating the selected smallest voxel value as the corresponding voxel of the Gaussian processed volume data.

After the noise eliminating process, the processed volume data may be transmitted to a display for displaying a volume rendered image with clearly showing the feature region at step S3595.

FIG. 12 illustrates the same cross sectional view produced from volume data processing results in accordance with at least one embodiment. FIG. 13 illustrates the same cross sectional view produced from threshold data processing results in accordance with at least one embodiment. FIG. 14 illustrates the same cross sectional view produced from the emphasized volume data in accordance with at least one embodiment.

As shown in FIG. 12, the background region of FIG. 12 becomes darker and the feature region of FIG. 12 becomes clearer and brighter as compared to FIG. 10. As shown in FIG. 13, the cross sectional view of FIG. 13 becomes blurred as compared to FIG. 9. As shown in FIG. 14, as compared to FIG. 14, a brighter region around the feature region is disappeared and the feature region becomes more emphasized.

Furthermore, as compared to FIG. 6, FIG. 12 illustrates the cross sectional view having the feature region (e.g., region of interest) clearer, sharpener, and brighter.

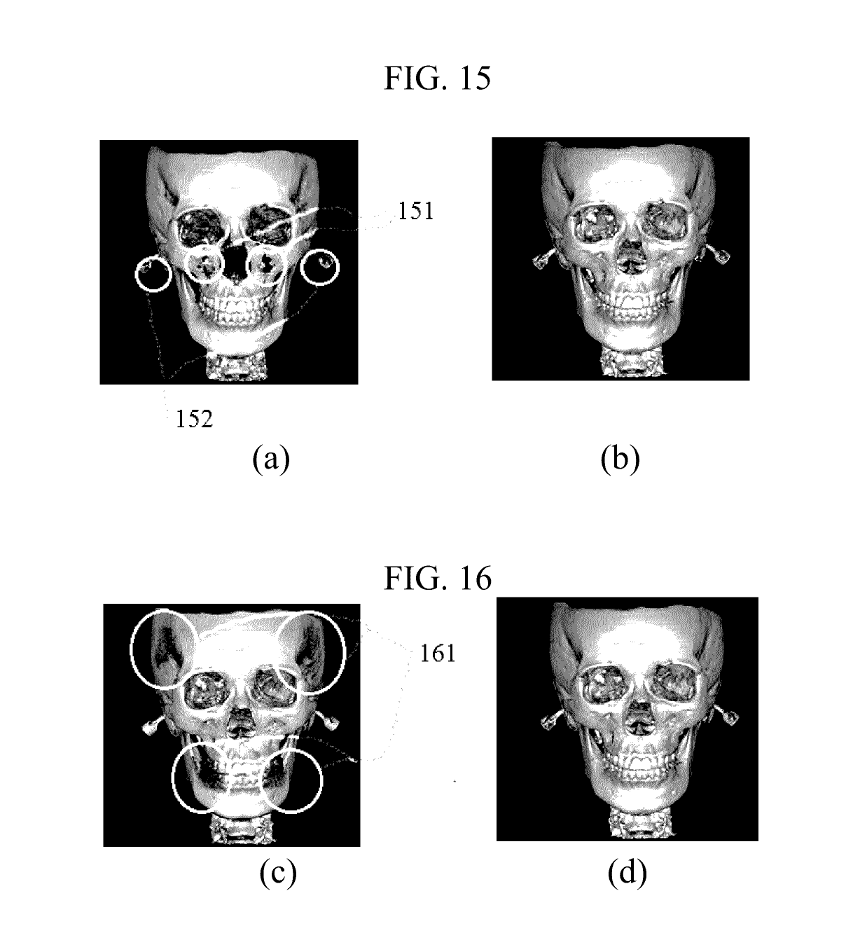

FIG. 15 and FIG. 16 illustrate comparison between a volume rendered image produced a related art and a volume rendered image produced in accordance with at least one embodiment.

Referring to FIG. 15, a diagram (a) illustrates a first volume rendered image produced using a first volume data according to a related art, and a diagram (b) illustrates a second volume rendered image produced using the same first volume data according to at least one embodiment. In the diagram (a), the first volume rendered image includes unclear regions (e.g. Infraorbital foramen 151 and TMJ 152) and significant noises. However, the second volume rendered image produced according to at least one embodiment is very clear and sharp as compared to the first volume rendered image. In particular, an expression level of a structure region (e.g., a feature region or a region of interest) in the second volume rendered image is improved as compared to the first volume rendered image.

Referring to FIG. 16, a diagram (c) illustrates a third volume rendered image produced using a second volume data according to a related art, and a diagram (d) illustrates a fourth volume render image produced using the same second volume data according to at least one embodiment. As shown in the diagram (c), the third volume rendered image includes significant noises 161. However, the fourth volume rendered image of the diagram (d) does not have noises. That is, the fourth volume rendered image is much clear and sharp as compared to the third volume rendered image of the diagram (c).

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of processing volume data, the method comprising:
obtaining volume data for producing a volume rendered image from a third entity;
generating feature data associated with a feature region in the volume rendered image using the obtained volume data;
generating threshold data by setting a predetermined threshold value associated with the feature data;
performing a thresholding process on the volume data using the generated threshold data; and
emphasizing the feature region by processing the thresholding-processed volume data using the threshold data.

2. The method of claim 1, wherein the feature region is formed of voxels having comparatively high brightness value than neighbor voxels.

3. The method of claim 1, wherein the generating feature data comprises:
identifying the feature region in the volume rendered image based on voxel values of the volume data; and
extracting data associated with the identified feature region from the obtained volume data, as the feature data.

4. The method of claim 3, wherein:
to identify the feature region and extract data associated with the identified feature region, a blob detection algorithm is used; and
the blob detection includes at least one of a difference of Gaussians (DoG) algorithm, a laplacian of Gaussians (LoG) algorithm, and a determinant of hessian (DoH) algorithm.

5. The method of claim 1, wherein the generating feature data comprises:
calculating a first Gaussian value of each voxel of the volume data by performing a first Gaussian process on each voxel of the volume data with a comparatively small size of a mask;
calculating a second Gaussian value of each voxel of the volume data by performing a second Gaussian process on each voxel of the volume data with a comparatively large size of a mask;
calculating a difference value between the first Gaussian value of each voxel and the second Gaussian value of a corresponding voxel;
detecting voxels having negative difference values among voxels of the volume data based on the calculated difference values; and
extracting detected voxels from the volume data.

6. The method of claim 1, wherein the generating threshold data comprises:
performing a first thresholding process on the feature data using a predetermined threshold filter; and
determining, as the threshold data, threshold values of the feature data by performing an averaging process on each voxel of the first thresholding-processed feature data using a predetermined size of a mask.

7. The method of claim 6, wherein the performing a first thresholding process comprises:
comparing a predetermined threshold filter value and a corresponding voxel value of the feature data;
selecting a value greater than the other based on the comparison result; and
assigning the selected value to the corresponding voxel of the feature data.

8. The method of claim 1, wherein the performing a thresholding process on the volume data comprises:
comparing each voxel value of the generated threshold data and a corresponding voxel value of the volume data;
selecting one greater than the other; and
assigning the selected one to the corresponding voxel value of the volume data.

9. The method of claim 1, wherein the emphasizing the feature region comprises:
processing each voxel of the thresholding-processed volume data using a predetermined sobel mask and generating volume data processing results;
processing each voxel of the threshold data using a predetermined sobel mask and generating threshold data processing results;
comparing the generated volume data processing results and the threshold data processing results; and
setting at least one of the volume data processing results to a predetermined reference value when the one is smaller than a corresponding threshold data processing result.

10. The method of claim 9, further comprising:
performing a Gaussian process on each voxel of the emphasized volume data; and
performing a noise eliminating process on the Gaussian processed volume data.

11. The method of claim 10, wherein the performing a noise eliminating process comprises:
comparing each voxel of the Gaussian processed volume data with adjacent voxels;
selecting the smallest voxel value based on the comparison result; and
allocating the selected smallest voxel value as the corresponding voxel of the Gaussian processed volume data.

12. The method of claim 1, wherein:
in order to emphasize the feature region, an edge detection algorithm is used; and
the edge detection algorithm includes a sobel operator, a differential edge detection, and a canny edge detector.

13. A non-transitory computer readable recording medium, which when executed, performs a method of processing volume data, the method comprising:
obtaining volume data for producing a volume rendered image from a third entity;
generating feature data associated with a feature region in the volume rendered image using the obtained volume data;
generating threshold data by setting a predetermined threshold value associated with the feature data;
performing a thresholding process on the volume data using the generated threshold data; and
emphasizing the feature region by processing the thresholding-processed volume data using the threshold data.
